(19) United States
(12) Patent Application Publication
(10) Pub. No.: US 2014/0037801 A1
(43) Pub. Date: Feb. 6, 2014

(54) COOLING VESSEL

(71) Applicants: Robert P. Cappadora, Bethpage, NY (US); Anthony M. Cappadora, Bethpage, NY (US)

(72) Inventors: Robert P. Cappadora, Bethpage, NY (US); Anthony M. Cappadora, Bethpage, NY (US)

(21) Appl. No.: 13/562,830

(22) Filed: Jul. 31, 2012

(51) Int. Cl. B65D 81/18; A23C 3/05

(52) U.S. Cl. 426/109; 426/393; 426/392

(57) ABSTRACT

A food container including an inner wall defining a food-containing cavity, and an outer wall defining a geometry of the food container. The outer wall is in contact with the inner wall to provide a unitary structure encapsulating a chamber between the inner wall and the outer wall of the food container. An aqueous salt solution is contained within the chamber between the inner wall and the outer wall. The aqueous salt solution has a water to salt by volume ratio that ranges from 2.5 parts water to 1 part salt to 3.5 parts water to 1 part salt. Following removal of the food container from a refrigeration unit, the aqueous salt solution of the food container maintains a temperature of a foodstuff positioned within the food-containing cavity with a range from −0.5° C. and 10° C.

### FIELD OF THE INVENTION

The methods and structures disclosed herein are related to maintaining food products at selected temperatures.

### BACKGROUND

Insulated containers for storing perishable items, such as food products, at pre-determined temperatures are known. Typically, these insulated containers include an insulating wall that surrounds the item, and an insulating lid, which fits in a sealing arrangement onto the container to maintain an internal container temperature. The difficulty with these types of containers is that they lose their ability to cool the food products contained therein shortly after removed from a refrigeration unit, or once the container is opened.

### SUMMARY

In one embodiment, a method of maintaining food products at a desired temperature is provided that may begin with providing a food container having a cavity for containing a food product The food container may also include at least one surface including an enclosed chamber containing an aqueous salt solution. The aqueous salt solution may have a water to salt ratio that ranges from 2.5:1 to 3.5:1 by volume. More specifically, the aqueous salt solution may have a water to salt ratio by volume that ranges from 2.5 parts water to 1 part salt to 3.5 parts water to 1 part salt. The food container may be positioned within a refrigeration container having a temperature within a range of −18° C. to 10° C. Typically, after removing the food container from the refrigeration container, a food product may be positioned within the cavity of the food container, and the aqueous salt solution maintains the temperature of the food product with a range from −0.5° C. and 10° C. for a time period greater than 30 minutes from when the food container is removed from the refrigeration container.

In another aspect, a food container is provided that in one embodiment includes an inner wall defining a food-containing cavity, and an outer wall defining a geometry of the food container. The outer wall is in contact with the inner wall to provide a unitary structure encapsulating a chamber between the inner wall and the outer wall of the food container. An aqueous salt solution is contained within the chamber between the inner wall and the outer wall. The aqueous salt solution has a water to salt ratio that ranges from 2.5:1 to 3.5:1 by volume. More specifically, the aqueous salt solution may have a water to salt ratio by volume that ranges from 2.5 parts water to 1 part salt to 3.5 parts water to 1 part salt.

### DESCRIPTION OF SEVERAL VIEWS OF THE DRAWINGS

The following detailed description, given by way of example and not intended to limit the present disclosure solely thereto, will best be appreciated in conjunction with the accompanying drawings, wherein like reference numerals denote like elements and parts, in which:

FIG. 1A is a perspective view of one embodiment of a food container including a chamber containing an aqueous salt solution having a water to salt ratio that ranges from 2.5:1 to 3.5:1 by volume, in accordance with one embodiment of the present disclosure.

FIG. 1B is a side cross-sectional three dimensional view of one embodiment of a food container, in accordance with the present disclosure.

FIG. 2 is a side cross-sectional view of a food container that is depicted in FIG. 1A, which depicts an unfilled chamber that is contained within the sidewall of the food container, in accordance with one embodiment of the present disclosure.

FIG. 3 is a side cross-sectional view of a food container that is depicted in FIG. 2, which depicts the chamber filled with the aqueous salt solution, in accordance with one embodiment of the present disclosure.

FIG. 4 is a plot of the temperature of the aqueous salt solution present in the freezer compartment of a refrigerator as a function of time, in accordance with one embodiment of the present disclosure.

FIG. 5 is a plot of temperature of the aqueous salt solution that is removed from the freezer compartment of the refrigerator as a function of time, in accordance with one embodiment of the present disclosure.

FIG. 6 is a plot of the temperature of a milk containing food product contained within a food container including a cooling mechanism provided by the aqueous salt solution as a function of time from when the food container was removed from the freezer compartment of the refrigerator. FIG. 6 also includes a comparative example provided by a plot of the temperature of a milk containing food product within a food container that does not include the aqueous salt solution.

### DETAILED DESCRIPTION

Detailed embodiments of the methods and structures of the present disclosure are described herein; however, it is to be understood that the disclosed embodiments are merely illustrative of the disclosed methods and structures that may be embodied in various forms. In addition, each of the examples given in connection with the various embodiments of the disclosure are intended to be illustrative, and not restrictive. References in the specification to “one embodiment”, “an embodiment”, “an example embodiment”, etc., indicate that the embodiment described may include a particular feature, structure, or characteristic, but every embodiment may not necessarily include the particular feature, structure, or characteristic.

Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the methods and structures of the present disclosure. For purposes of the description hereinafter, the terms “upper”, “lower”, “top”, “bottom”, and derivatives thereof shall relate to the disclosed structures, as they are oriented in the drawing figures. The terms “positioned on” mean that a first element, such as a first structure, is present on a second element, such as a second structure, wherein intervening elements, such as an interface structure, may be present between the first element and the second element. The term “direct contact” means that a first element, such as a first structure, and a second element, such as a second structure, are connected without any intermediary structures at the interface of the two elements.

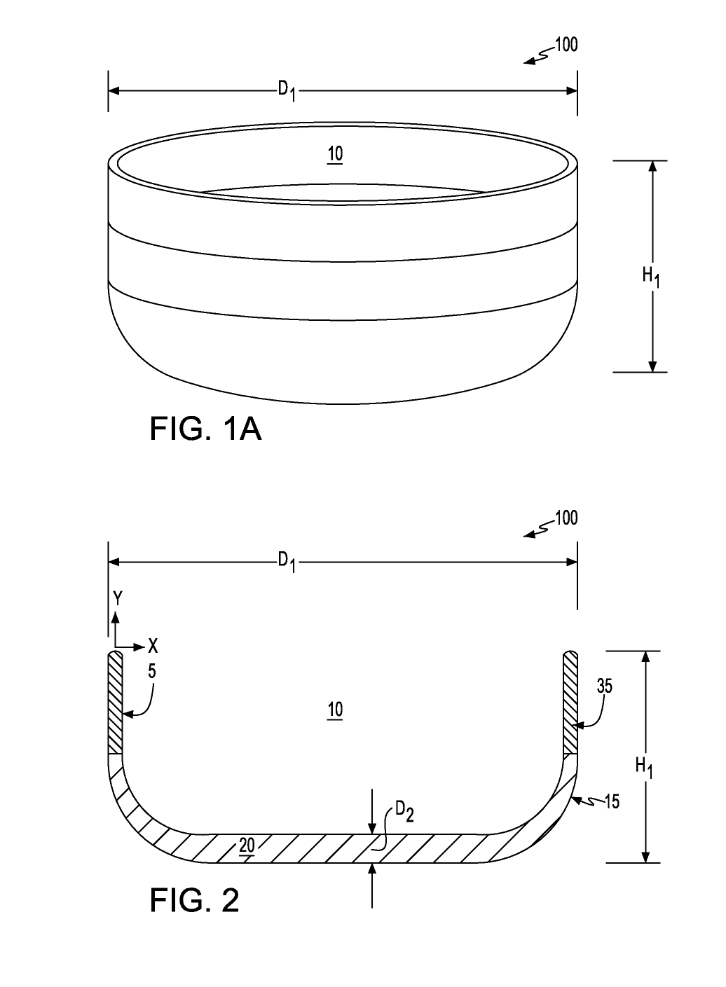

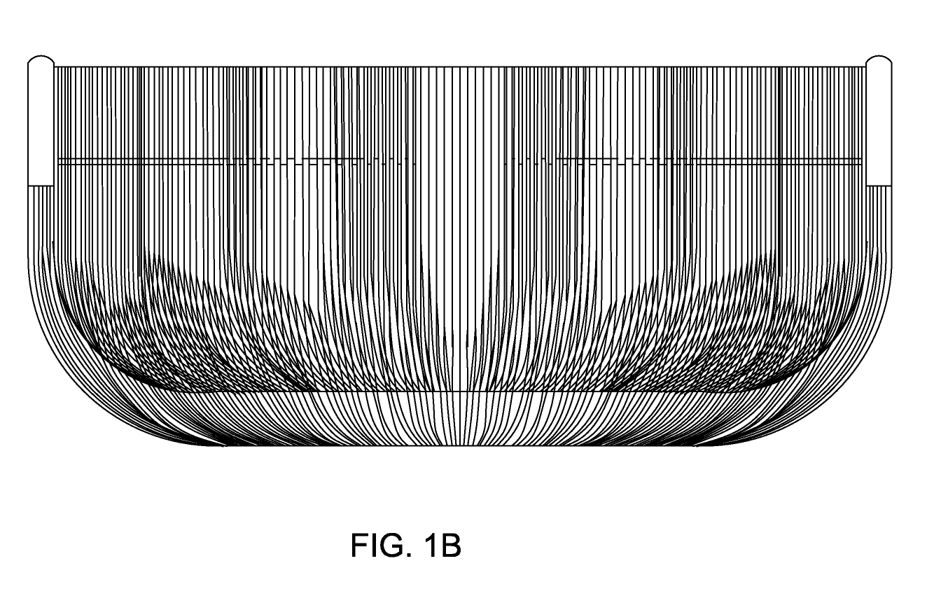

The methods and structures disclosed herein are directed to food containers that employ an aqueous salt solution for cooling food products. Referring to FIGS. 1A-3, in one embodiment, the food container 100 includes an inner wall 5 defining a food-containing cavity 10, and an outer wall 15 defining a geometry of the food container 100. The food-containing cavity 10 may have any size and shape that is suitable for containing food products, such as a liquid milk with cereal, ice cream and fruit. Although, the food-containing cavity 10 is depicted as having a curved sidewall and base, the food-containing cavity 10 may also be multi-sided. In one embodiment, the inner wall 5 and the outer wall 15 of the food container 100 may each be composed of a plastic. For example, each of at least one of the inner wall 5 and the outer wall 15 may be composed of at least one of polyethylene terephthalate (PET), high density polyethylene (HDPE), polyvinyl chloride (PVC), low density polyethylene (LDPE), polypropylene (PP) and polystyrene (PS). The inner wall 5 and the outer wall 15 of the food container 100 may also be composed of other materials, such as metals. For example, in some embodiments, the inner wall 5 and the outer wall 15 may each be composed of an aluminum alloy, which can include 90 wt. % to 97 wt. % aluminium, less than 5.5 wt. % magnesium, less than 1.6 wt. % manganese, less than 0.15 wt. % chromium and some trace amounts of iron, silicon and copper. In another example, the inner wall 5 and the outer wall 15 may each be composed of tin plated steel.

The geometry of the food container 100 may be any shape that is suitable for holding food products, including but not limited to, bowls and cups. In the embodiment that is depicted in FIGS. 1A-3, the food container 100 may be bowl, in which the diameter D₁ of the food-containing cavity 10 ranges from 5 cm to 30 cm. In another embodiment, the diameter D₁ of the food-containing cavity 10 ranges from 10 cm to 25 cm. In one example, the diameter D₁ of the food-containing cavity 10 is 15 cm. In one embodiment, the height H₁ of the food container 100 ranges from 3 cm to 12 cm. In another embodiment, the height H₁ of the food container 100 ranges from 5 cm to 10 cm. In one embodiment, the wall thickness for each of the inner wall 5 and the outer wall 15 may range from 0.35 cm to 0.65 cm. In another embodiment, the wall thickness for each of the inner wall 5 and the outer wall 15 may range 0.4 cm to 0.6 cm. In one embodiment, the outer wall 15 is in contact with the inner wall 5 to provide a unitary structure encapsulating a chamber 20 between the inner wall 5 and the outer wall 15.

The term “unitary structure” as used herein means that the inner wall 5 and the outer wall 15 are joined so that the interface between the inner wall 5 and the outer wall 15 is sealed to contain an aqueous salt solution 25 within the chamber 20 that is defined by the space between the inner and outer wall 5, 15. In some embodiments, because the inner wall 5 and the outer wall 15 are sealed, the aqueous salt solution 25 may not be removed from the chamber 20. By “encapsulated” it is meant that the chamber 20 is enclosed by the inner wall 5 and the outer wall 15 so that the aqueous salt solution 25 is entirely separated from the food-containing cavity 10 and the ambient surrounding the outer wall 15. In some embodiments, the inner wall 5 and the outer wall 15 of the food container 100 are in contact at a rim of the food container that defines the opening to the food-containing cavity 10. In one embodiment, in which the inner wall 5 and the outer wall 15 are composed of a plastic, the inner wall 5 and the outer wall 15 may be joined by a co-molding process, in which the inner wall 5 and the outer wall 15 are formed simultaneously, wherein the interface between the inner wall 5 and the outer wall 15 merge into an alloyed portion. In another embodiment, the interface between the inner wall 5 and the outer wall 15 may be joined to provide a unitary structure using an adhesive, such as a glue. In yet another embodiment in which the inner wall 5 and the outer wall 15 are composed of a plastic, the inner wall 5 and the outer wall 15 may be joined with a plastic welding method. In the embodiments in which the inner wall 5 and the outer wall 15 are composed of a metal, the inner wall 5 and the outer wall 15 may be joined using adhesives and welding methods, as well as mechanical deformation methods, such as crimping and necking.

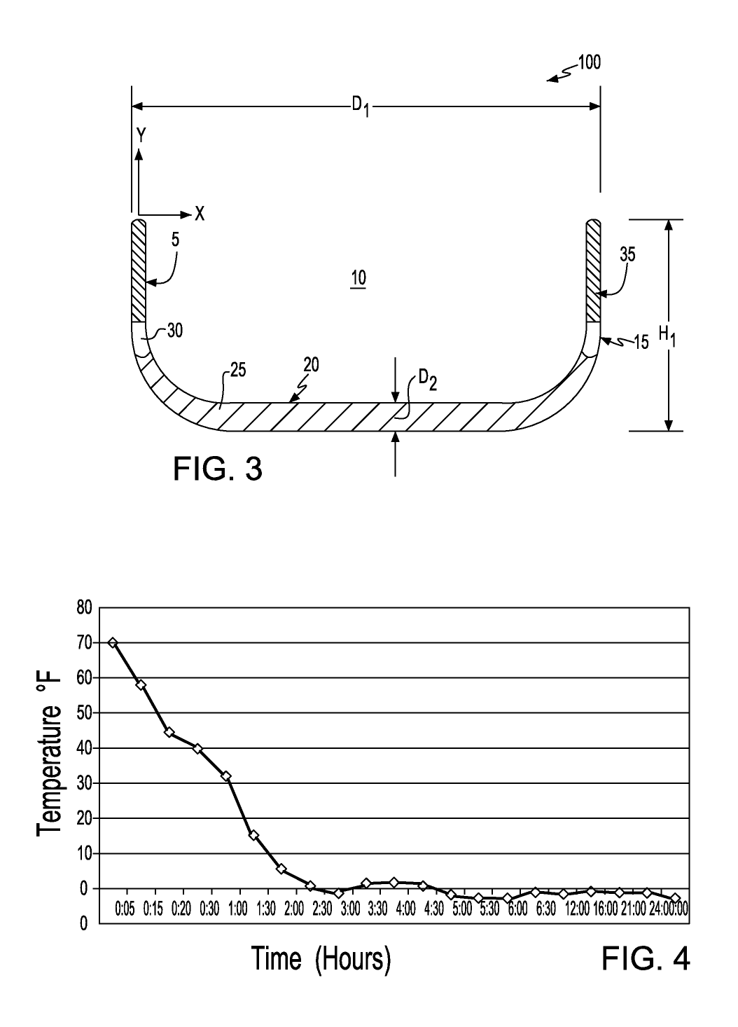

In each of the aforementioned embodiments, the inner wall 5 and the outer wall 15 are in direct contact at the sealed interface between the inner and outer wall 5, 15 of the food container 100. Referring to FIGS. 2 and 3, in some embodiments, the sealed interface between the inner and outer wall 15 of the food container 100 provides a solid rim 35 that provides the opening to the food-containing cavity 10. In yet another embodiment, the interface between the inner wall 5 and the outer wall 15 may be provided by a cap structure (not shown). The cap structure (also referred to as ring structure) may provide the rim of the food container 100 that defines the opening of the food container 100 to the food-containing cavity 10. In this embodiment, the inner wall 5 is not in direct contact to the outer wall 15, but the inner wall 5 is in contact with the outer wall 15 through the cap structure.

Referring to FIGS. 2 and 3, in one embodiment, the distance D₂ separating the inner wall 5 from the outer wall 15 that defines the chamber 20 ranges from 0.15 cm to 0.45 cm. In another embodiment, the distance D₂ separating the inner wall 5 from the outer wall 15 may range from 0.25 cm to 0.35 cm. In one example, the distance D₂ separating the inner wall 5 from the outer wall 15 may be 0.3 cm. Although FIGS. 2 and 3 depict a food container 100 in which the majority of the chamber 20 for containing the aqueous salt solution 25 is present in the base of the food container 100, in some embodiments the majority of the chamber 20 may be present in the sidewalls of the food container 100, and the base of the food container 100 may be solid.

Referring to FIG. 3, an aqueous salt solution 25 is contained within the chamber 20 between the inner wall 5 and the outer wall 15 of the food container 100. The aqueous salt solution 25 has a composition and concentration of salt that may be selected to keep the aqueous salt solution 25 from reaching a temperature that is low enough that it will freeze the food product that are contained within the food-containing cavity 10. The composition and concentration of salt within the aqueous salt solution 25 may also be selected to provide that the salt is dissolved into a water solvent when mixing the salt and the water to form the aqueous salt solution 25. In one embodiment, the salt that is selected for the aqueous salt solution 25 is sodium chloride (NaCl). In one embodiment, the sodium chloride (NaCl) that is selected from the aqueous salt solution is food grade sodium chloride (NaCl) having an impurity level of not more than 2 mg/kg of copper, an impurity level of not more than 2 mg/kg of lead, an impurity level of not more than 0.5 mg/kg of cadmium, and an impurity level of not more than 0.1 mg/kg of mercury.

Other examples of sodium containing salts that may be suitable for the aqueous salt solution 25 include sodium acetate, sodium adipate, sodium alginate, sodium aluminium phosphate, sodium aluminosilicate, sodium ascorbate, sodium benzoate, sodium bicarbonate, sodium bisulfite (sodium hydrogen sulfite), sodium carbonate, sodium carboxymethylcellulose, sodium citrates, sodium dehydroacetate, sodium erythorbate, sodium erythorbin, sodium ethyl para-hydroxybenzoate, sodium ferrocyanide, sodium formate, sodium fumarate, sodium gluconate, sodium hydrogen acetate, sodium hydroxide, sodium lactate, sodium malates, sodium metabisulfite, sodium methyl para-hydroxybenzoate, sodium nitrate, sodium nitrite, sodium orthophenyl phenol, sodium propionate, sodium propyl para-hydroxybenzoate, sodium sorbate, sodium stearoyl lactylate, sodium succinates, sodium salts of fatty acids, sodium sulfite, sodium tartrates, sodium tetraborate, and combinations thereof.

In another embodiment, a salt of the aqueous salt solution 25 may be a compound or a sodium salt that is selected from the group consisting of ascorbyl palmitate (palmitoyl L-ascorbic), calcium L-ascorbate, calcium hypophosphite, calcium propionate, carboxymethyl cellulose, cellulose acetate, copper (cupric) gluconate, copper (cupric) sulfate, cuprous iodide, erythorbic acid (D-isoascorbic acid), ethyl cellulose, hydroxypropylmethyl cellulose, L-ascorbic acid, manganous hypophosphite, methylcellulose, potassium hypophosphite, propionic acid, sodium carboxymethyl cellulose, sodium L-ascorbate, sodium erythorbate (sodium D-isoascorbate), sodium hydrosulfite, sodium hypophosphite, sodium propionate, sodium thiosulfate and combinations thereof. It is noted that the above salt compositions for the aqueous salt solution 25 are provided for illustrative purposes only, and are not intended to limit the present disclosure to only the above listed salt compositions. In one embodiment, the salt for the aqueous salt solution 25 may be any salt that can be safely consumed by humans.

The solvent of the aqueous salt solution 25 may be tap water or purified water. Purified water is water from any source that is processed to remove impurities. In some embodiments, the purified water that provides the solvent of the aqueous salt solution 25 may be distilled water or deionized (DI) water. Distilled water may be produced by a process of distillation and has an electrical conductivity of not more than 10 μS/cm and total dissolved solids of less than 10 mg/litre. Deionized water, which may also be referred to as demineralized water, is water that has had its mineral ions removed, such as cations from sodium, calcium, iron, copper and anions such as chloride and bromide. Other forms of purified water that are suitable for the aqueous salt solution 25 include water that has been purified by reverse osmosis, carbon filtration, microfiltration, ultrafiltration, ultraviolet oxidation, or electrodialysis.

The salt composition and concentration of the aqueous salt solution 25 is selected to provide that the salt is dissolved into the aqueous solvent, and to keep the aqueous salt solution 25 from reaching a temperature that is low enough that it will freeze the food products that are contained in the food containing cavity 10. For example, in some embodiments, the concentration of salt within the aqueous salt solution 25 should not be so great as to separate from solution, e.g., precipitate from solution, or form crystallites in the aqueous salt solution 25. Further, in some embodiments, the concentration of the salt should not be so low that it is ineffective in keeping the temperature of the aqueous salt solution 25 from dropping to a level that would freeze the food products being contained within the food-containing cavity 10. The concentration of the salt within the aqueous salt solution 25 has a water to salt ratio that ranges from 2.5 parts water to 1 part salt to 3.5 parts water to 1 part salt by volume. In another embodiment, the water to salt ratio range from 2.75 parts water to 1 part salt to 3.25 parts water to 1 part salt by volume. In one application, in which the food product being contained in the food-containing cavity 10 includes liquid milk, the aqueous salt solution 25 is selected to maintain a cooled temperature of the liquid milk that is below the ambient temperature at which the food products are being consumed, and above the freezing temperature of the liquid milk. The ambient temperature is the temperature of the air in the environment in which the food product is being consumed. The mixing of the water solvent and the salt to provide the aqueous salt solution 25 may be provided by mechanical mixing, in which dissolution of the salt may be aided by heating the water solvent.

In some embodiments, the aqueous salt solution 25 may be positioned in the chamber 20 before the inner wall 5 and the outer wall 15 are joined at their interface to seal the chamber 20. In other embodiments, the aqueous salt solution 25 may be introduced to the chamber 20 after the chamber 20 has been sealed. In these embodiments, the aqueous salt solution 25 may be introduced to the chamber 20 through an opening that is formed in at least one of the inner wall 5 and the outer wall 15. The opening may then be closed after the aqueous salt solution 25 is positioned within the chamber 20 using a plug (not shown). The plug may be engaged to the opening mechanically by a threaded or frictional engagement, or the plug by may adhesively engaged to the opening. It is noted that the above description for positioning the aqueous salt solution 25 within the chamber 20 is provided for illustrative purposes only, and is not intended to limit the present disclosure to only these embodiments, as other method of forming the food container 100 have been contemplated, and are within the scope of the present disclosure. In some embodiments, the aqueous salt solution 25 fills the chamber 20 that is positioned between the inner wall 5 and the outer wall 15 in its entirety. In other embodiments, the aqueous salt solution 25 only fills a portion of the chamber 20, wherein an air gap 30 may be present to allow for expansion and contraction of the aqueous salt solution 25 and the food container 100 in response to temperature changes. In some other embodiments, the aqueous salt solution 25 only fills a portion of the chamber 20, wherein the air gap 30 may be present to allow for the aqueous salt solution 25 that provides the cooling means for the food containing cavity 10 to move so that it is proximate to the contents of the food containing cavity 10 as the food containing cavity 10 is tilted. For example, the air gap 30 may allow for the aqueous salt solution 25 to “mirror” the contents contained within the food containing cavity 10 so that the contents contained within the food containing cavity 10 are in closest proximity to the salt containing solution as the food containing cavity 10 is tilted or moved. In some instances, this can allow for the food container 100 to be stored in any position within a refrigeration container without impacting the ability of the food container 100 to cool the contents of the food containing cavity 10 once it is removed from the refrigeration container.

The food container 100 disclosed herein may be stored within a refrigeration container, in which the temperature of the aqueous salt solution 25 is reduced. The refrigeration container may be an ice box, a cooler, a freezer, or a refrigerator. It is noted that these types of refrigeration containers are provided for illustrative purposes only, and are not intended to limit to the present disclosure to only these types of refrigeration containers, as any container that reduces the temperature of the contents contained therein relative to an exterior ambient temperature can provide a refrigeration container suitable for storing the food container 100. The refrigeration container may have an internal temperature within a range of −23° C. to 10° C. In another embodiment, the refrigeration container may have an internal temperate with a range of −10° C. to 5° C. In one embodiment, the refrigeration container is a refrigerator that maintains an internal temperature ranging from 1° C. to 10° C. In another embodiment, the refrigeration container is a refrigerator that maintains an internal temperature ranging from 3° C. to 5° C. In one embodiment, the refrigeration container is a freezer that maintains an internal temperature ranging from −23° C. to −18° C.

The food container 100 may remain within the refrigeration container for a time period to reduce the temperature of the aqueous salt solution 25 to a temperature that may be proximate to the refrigeration container, but not to a temperature that is so low that it will result in freezing of the food products that are to be positioned within the food-containing cavity 10 after the food container 100 is removed from the refrigeration container. Typically, the food container 100 is positioned within the refrigeration container for greater than 15 minutes to reduce the temperature of the aqueous salt solution 25. In another embodiment, the food container 100 may be stored in the refrigeration container for greater than 30 minutes.

Typically, after the food container 100 is removed from the refrigeration container, at least one food product may be positioned within the cavity, i.e., food-containing cavity 10, of the food container 100. In one embodiment, in which the food product that is contained within the food-containing cavity 10 includes liquid milk, such as a liquid milk that is mixed with cereal, the salt composition and concentration of salt within the aqueous salt solution 25 ensures that the liquid milk is cooled, but is not frozen, i.e., the milk remains in the liquid state. The exact freezing point of milk (also called the melting point) varies slightly according to the individual cow, the breed, the time of day/season that the milk is collected, the type of feed that the cow receives, etc. The majority of cows produce milk with a natural freezing point of −0.5250° C. to −0.5650° C., with an average of about −0.5400° C. Therefore, in the embodiments in which food products including liquid milk are to be cooled in the food-containing cavity 10 of the food container 100, the aqueous salt solution 25 is selected to cool the contents of the food-containing cavity 10 without reducing the temperature of the contents within the food containing cavity 10 to the freezing temperature of milk, e.g., −0.5250° C., −0.540° C., or −0.5650° C. One example of an aqueous salt solution 25 that is suitable for cooling food products including liquid milk that are positioned within the food-containing cavity 10 without freezing the liquid milk is an aqueous salt solution 25 that is composed of sodium chloride (table salt) and distilled water, in which concentration of the salt within the aqueous salt solution 25 is equal to ⅓ a cup of salt to 1 cup of water.

In some embodiments, the food container 100 including the aqueous salt solution 25 can maintain the temperature of food products contained within the food containing cavity 10 at temperatures of 10° C. (50° F.) or less for time periods greater than 30 minutes from when the food container is removed from a refrigeration container having a temperature between −9.44° C. (15° F.) and −26.1° C. (−15° F.). The food container 100 including the aqueous salt solution 25 can maintain the temperature of food products contained within the food containing cavity 10 at temperatures of 10° C. or less for time periods ranging from 30 minutes to 2 hours from when the food container is removed from a refrigeration container having a temperature between −9.44° C. (15° F.) and −26.1° C. (−15° F.). In one embodiment, the food container 100 including the aqueous salt solution 25 can maintain the temperature of food products contained within the food containing cavity 10 at temperatures of 10° C. or less for time periods as great as 1.5 hours from when the food container is removed from a refrigeration container having a temperature between −9.44° C. (15° F.) and −26.1° C. (−15° F.). In some embodiments, the aqueous salt solution 25 maintains a temperature of the food product, e.g., combination of cereal and liquid milk, that is contained within the food-containing cavity 10 within a range from −0.525° C. to 10° C. for a time period or up to 1 hour from when the food container 100 is removed from the refrigeration container. In another embodiment, the aqueous salt solution 25 maintains a temperature of the food product that is contained within the food-containing cavity 10 within a range from 0° C. to 8° C. for a time period or up to 45 minutes from when the food container 100 is removed from the refrigeration container. In yet another embodiment, the aqueous salt solution 25 maintains a temperature of the food product that is contained within the food-containing cavity 10 within a range from 0° C. to 5° C. for a time period or up to 30 minutes from when the food container 10 is removed from the refrigeration container.

Although the food container 100 has been described above for cooling food products containing liquid milk, it is noted that the food container 100 is not limited to only this application, as other food products may be positioned within the food containing cavity 10 to be cooled by the food container 100. Some examples of food products that may be positioned within the food containing cavity 10 of the food container 100 include ice cream, frozen custard, frozen yogurt, sorbet, gelato, ais kacang, dondurma, frozen custard, halo-halo, ice milk, popsicle (ice pop or ice lolly), sweatened ices, kulfi, mellorine, parevine, sherbet, snow cones and combinations thereof. Any food product which is desired to be consumed at a temperature that is less than the ambient temperature is within the scope of the present disclosure.

The following examples are provided to further illustrate the methods and structures of the present disclosure and demonstrate some advantages that arise therefrom. It is not intended that the present disclosure be limited to the specific examples described herein.

### Measurement of Temperature of Aqueous Salt Solution in Freezer as a Function of Time

An aqueous salt solution was prepared from sea salt (NaCl) and distilled water (H₂O). The ratio of distilled water to sea salt was 3.5 cups of distilled water to 1 cup of sea salt. The sea salt was added to the distilled water and mixed until the sea salt was dissolved. The aqueous salt solution was then positioned within a coffee cup and positioned within the freezer section of a refrigerator. The freezer section of the refrigerator had a temperature of approximately 0° F. (−18° C.). The temperature of the aqueous salt solution was taken as a function of time while the aqueous salt solution remained in the freezer section of the refrigerator between temperature measurements. The data collected is included in Table 1, which is plotted in FIG. 4.

TABLE 1

| Time | | |
|---|---|---|
| (Hours:Minutes) | Temperature ° F. | Temperature ° C. |
| 0:00 | 69.8 | 21.00 |
| 0:05 | 58 | 14.44 |
| 0:15 | 44.4 | 6.89 |
| 0:20 | 39.8 | 4.33 |
| 0:30 | 31.8 | −0.11 |
| 1:00 | 15.1 | −9.39 |
| 1:30 | 5.7 | −14.61 |
| 2:00 | 0.7 | −17.39 |
| 2:30 | −1.1 | −18.39 |
| 3:00 | 1.5 | −16.94 |
| 3:30 | 1.7 | −16.83 |
| 4:00 | 1.2 | −17.11 |
| 4:30 | −1.6 | −18.67 |
| 5:00 | −2.7 | −19.28 |
| 5:30 | −2.6 | −19.22 |
| 6:00 | −0.9 | −18.28 |
| 6:30 | −1.3 | −18.50 |
| 12:00 | −0.8 | −18.22 |
| 16:00 | −1 | −18.33 |
| 21:00 | −1.1 | −18.39 |
| 24:00:00 | −2.6 | −19.22 |

As indicated by the data collected in Table 1, and plotted in FIG. 4, the aqueous salt solution did not freeze, i.e., have a phase conversion from liquid to solid states, for temperatures as low as about −3° F., for a time period as great as 24 hours.

Measurement of Temperature of Aqueous Salt Solution after Being Removed from a Freezer as a Function of Time

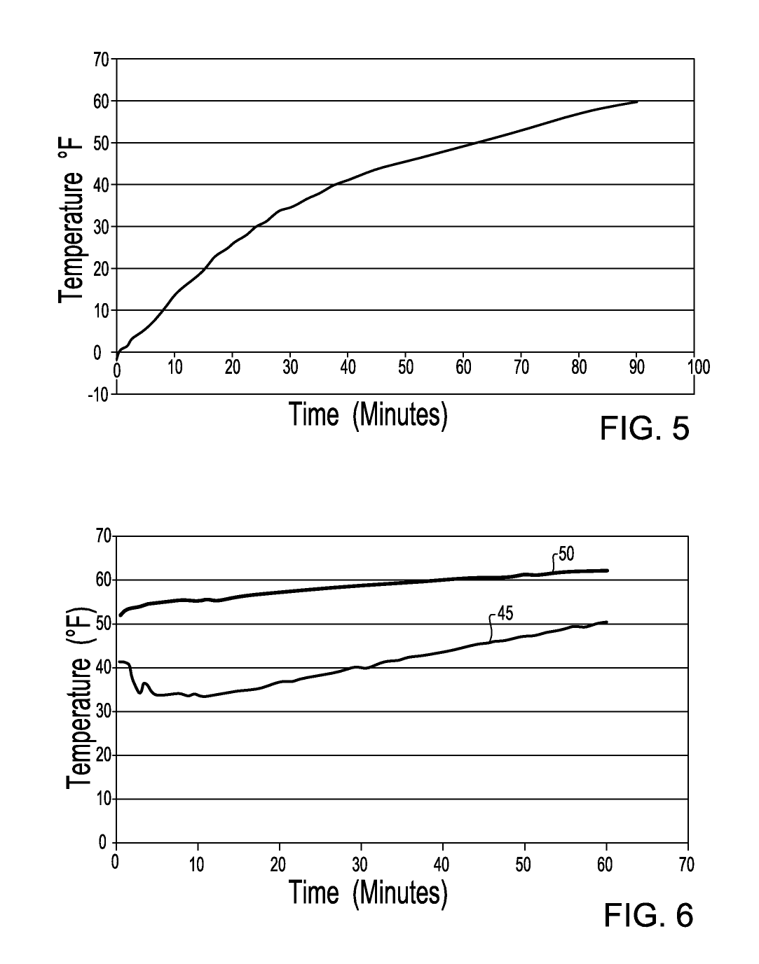

An aqueous salt solution was prepared from sea salt (NaCl) and distilled water (H₂O). The ratio of distilled water to sea salt was 3.5 cups of distilled water to 1 cup of sea salt. The sea salt was added to the distilled water and mixed until the sea salt was dissolved. The aqueous salt solution was then positioned within a coffee cup and positioned within the freezer section of a refrigerator. The freezer section of the refrigerator had a temperature of approximately 0° F. (−18° C.). Once the temperature of the aqueous salt solution reached approximately 0° F. (−18° C.), the aqueous salt solution was removed from the freezer. Once removed from the freezer section of the refrigerator, the temperature of the aqueous salt solution was taken in increments of 30 seconds for a time period of 90 minutes. The aqueous salt solution remained outside of the freezer section of the refrigerator between temperature measurements. The data collected is included in Table 2, which is plotted in FIG. 5.

| Time | Temp |
|---|---|
| (minutes) | (F.) |
| 0 | −1.7 |
| 0.5 | −0.6 |
| 1 | 0.9 |
| 1.5 | 1.3 |
| 2 | 1.7 |
| 2.5 | 2.9 |
| 3 | 3.5 |
| 3.5 | 4.1 |
| 4 | 4.6 |
| 4.5 | 5.1 |
| 5 | 5.8 |
| 5.5 | 6.3 |
| 6 | 6.9 |
| 6.5 | 7.5 |
| 7 | 8.2 |
| 7.5 | 9.1 |
| 8 | 10 |
| 8.5 | 10.7 |
| 9 | 11.5 |
| 9.5 | 12.4 |
| 10 | 13.3 |
| 10.5 | 14.1 |
| 11 | 14.7 |
| 11.5 | 15.3 |
| 12 | 15.9 |
| 12.5 | 16.5 |
| 13 | 17.1 |
| 13.5 | 17.7 |
| 14 | 18.4 |
| 14.5 | 19 |
| 15 | 19.6 |
| 15.5 | 20.3 |
| 16 | 21.1 |
| 16.5 | 22 |
| 17 | 22.7 |
| 17.5 | 23.3 |
| 18 | 23.8 |
| 18.5 | 24.2 |
| 19 | 24.7 |
| 19.5 | 25.3 |
| 20 | 25.9 |
| 20.5 | 26.5 |
| 21 | 26.8 |
| 21.5 | 27.2 |
| 22 | 27.7 |
| 22.5 | 28.1 |
| 23 | 28.5 |
| 23.5 | 29.1 |
| 24 | 29.7 |
| 24.5 | 30.2 |
| 25 | 30.6 |
| 25.5 | 30.9 |
| 26 | 31.5 |
| 26.5 | 32 |
| 27 | 32.6 |
| 27.5 | 33 |
| 28 | 33.6 |
| 28.5 | 34 |
| 29 | 34.3 |
| 29.5 | 34.4 |
| 30 | 34.7 |
| 30.5 | 35 |
| 31 | 35.4 |
| 31.5 | 35.7 |
| 32 | 36 |
| 32.5 | 36.2 |
| 33 | 36.6 |
| 33.5 | 37.1 |
| 34 | 37.2 |
| 34.5 | 37.6 |
| 35 | 38 |
| 35.5 | 38.3 |
| 36 | 38.6 |
| 36.5 | 39.1 |
| 37 | 39.6 |
| 37.5 | 39.9 |
| 38 | 40.1 |
| 38.5 | 40.4 |
| 39 | 40.6 |
| 39.5 | 41 |
| 40 | 41.3 |
| 40.5 | 41.6 |
| 41 | 41.8 |
| 41.5 | 42 |
| 42 | 42.2 |
| 42.5 | 42.4 |
| 43 | 42.7 |
| 43.5 | 43 |
| 44 | 43.1 |
| 44.5 | 43.4 |
| 45 | 43.6 |
| 45.5 | 43.9 |
| 46 | 44 |
| 46.5 | 44.2 |
| 47 | 44.4 |
| 47.5 | 44.6 |
| 48 | 44.8 |
| 48.5 | 44.9 |
| 49 | 45.2 |
| 49.5 | 45.4 |
| 50 | 45.6 |
| 50.5 | 45.8 |
| 51 | 46 |
| 51.5 | 46.1 |
| 52 | 46.3 |
| 52.5 | 46.4 |
| 53 | 46.6 |
| 53.5 | 46.8 |
| 54 | 46.9 |
| 54.5 | 47.1 |
| 55 | 47.3 |
| 55.5 | 47.5 |
| 56 | 47.7 |
| 56.5 | 47.8 |
| 57 | 48 |
| 57.5 | 48.2 |
| 58 | 48.4 |
| 58.5 | 48.6 |
| 59 | 48.8 |
| 59.5 | 49 |
| 60 | 49.1 |
| 65 | 50.9 |
| 70 | 53.1 |
| 75 | 55 |
| 80 | 57 |
| 85 | 58.5 |
| 90 | 59.8 |

As indicated by the data collected in Table 2, and plotted in FIG. 5, in one example the aqueous salt solution maintains a temperature of less than 50° F. for up to 60 minutes. In this example, the temperature of the aqueous salt solution was less than 60° F. for up to 90 minutes.

### Comparison of the Temperature of Milk Containing Food Products within a Food Container Including an Aqueous Salt Solution Cooling Mechanism to the Temperature of Milk Containing Food Products within a Food Container that does not Include an Aqueous Salt Solution Cooling Mechanism

An aqueous salt solution was prepared from sea salt (NaCl) and distilled water (H₂O). The ratio of distilled water to sea salt was 3.5 cups of distilled water to 1 cup of sea salt. The sea salt was added to the distilled water and mixed until the sea salt was dissolved. The aqueous salt solution was then positioned within a cavity present between the inner and outer walls of a plastic food container. A food container having the same geometry and material composition without including the aqueous salt solution was provided for the comparative example. Both the food container including the cavity filled with the aqueous salt solution and the food container for the comparative example were placed in a freezer compartment of a refrigerator at a temperature of approximately 0° F. for a time period of approximately 1 hour.

The food container including the cavity filled with the aqueous salt solution and the food container for the comparative example were then removed from the freezer, and a milk containing food product was placed in each of the food containers. The milk containing food product included 1 cup of dry cereal and 0.5 cups of fat free milk. The temperature of the milk containing food product that was present in the food container including the cavity filled with the aqueous salt solution, and the temperature of the milk containing food product that was present in food container for the comparative example, was taken within 30 seconds of the food containers being removed from the freezer. Thereafter, the temperature of the milk containing food product in each of the containers was taken approximately every 30 seconds for a time period of 90 minutes. The food containers remained outside of the freezer section of the refrigerator during the temperature measurements. The data collected is included in Table 3, which is plotted in FIG. 6. Referring to FIG. 6, the data line identified by reference number 45 represents the data collected from the milk containing food product that was present in the food container including the cavity filled with the aqueous salt solution. The data line identified by reference number 50 represents the data collected from the milk containing food product that was in the comparative example that did not include the aqueous salt solution.

TABLE 3

| | With | Without |
|---|---|---|
| Time | Solution | Solution |
| (Minutes) | (° F.) | (° F.) |
| 0.5 | 41.3 | 52 |
| 1 | 41.3 | 53 |
| 1.5 | 40.7 | 53.4 |
| 2 | 38.1 | 53.7 |
| 2.5 | 35.2 | 53.9 |
| 3 | 34.2 | 54.2 |
| 3.5 | 36.6 | 54.4 |
| 4 | 35.3 | 54.6 |
| 4.5 | 34.2 | 54.7 |
| 5 | 33.6 | 54.8 |
| 5.5 | 33.7 | 55 |
| 6 | 33.8 | 55.1 |
| 6.5 | 34 | 55.1 |
| 7 | 34 | 55.2 |
| 7.5 | 33.9 | 55.3 |
| 8 | 33.9 | 55.4 |
| 8.5 | 33.8 | 55.4 |
| 9 | 33.6 | 55.4 |
| 9.5 | 33.8 | 55.5 |
| 10 | 33.6 | 55.5 |
| 10.5 | 33.6 | 55.4 |
| 11 | 33.6 | 55.5 |
| 11.5 | 33.6 | 55.3 |
| 12 | 33.8 | 55.3 |
| 12.5 | 33.9 | 55.5 |
| 13 | 34 | 55.7 |
| 13.5 | 34.1 | 55.8 |
| 14 | 34.3 | 56 |
| 14.5 | 34.5 | 56.1 |
| 15 | 34.6 | 56.2 |
| 15.5 | 34.8 | 56.4 |
| 16 | 34.9 | 56.4 |
| 16.5 | 35.1 | 56.6 |
| 17 | 35.2 | 56.7 |
| 17.5 | 35.4 | 56.9 |
| 18 | 35.6 | 57 |
| 18.5 | 35.8 | 57.1 |
| 19 | 36 | 57.2 |
| 19.5 | 36.2 | 57.3 |
| 20 | 36.4 | 57.4 |
| 20.5 | 36.6 | 57.5 |
| 21 | 36.8 | 57.5 |
| 21.5 | 36.9 | 57.6 |
| 22 | 37.2 | 57.7 |
| 22.5 | 37.3 | 57.8 |
| 23 | 37.5 | 57.9 |
| 23.5 | 37.7 | 57.9 |
| 24 | 37.9 | 58 |
| 24.5 | 38.1 | 58.1 |
| 25 | 38.3 | 58.1 |
| 25.5 | 38.5 | 58.2 |
| 26 | 38.7 | 58.3 |
| 26.5 | 38.9 | 58.4 |
| 27 | 39.1 | 58.4 |
| 27.5 | 39.3 | 58.5 |
| 28 | 39.5 | 58.6 |
| 28.5 | 39.7 | 58.7 |
| 29 | 39.9 | 58.7 |
| 29.5 | 40.1 | 58.8 |
| 30 | 40 | 58.8 |
| 30.5 | 40 | 58.8 |
| 31 | 40.2 | 58.9 |
| 31.5 | 40.6 | 58.9 |
| 32 | 40.9 | 59 |
| 32.5 | 41.1 | 59.1 |
| 33 | 41.3 | 59.1 |
| 33.5 | 41.5 | 59.2 |
| 34 | 41.6 | 59.2 |
| 34.5 | 41.7 | 59.3 |
| 35 | 41.9 | 59.4 |
| 35.5 | 42.1 | 59.4 |
| 36 | 42.2 | 59.5 |
| 36.5 | 42.4 | 59.6 |
| 37 | 42.6 | 59.6 |
| 37.5 | 42.8 | 59.7 |
| 38 | 43 | 59.8 |
| 38.5 | 43.1 | 59.8 |
| 39 | 43.3 | 59.9 |
| 39.5 | 43.4 | 60 |
| 40 | 43.6 | 60 |
| 40.5 | 43.9 | 60.1 |
| 41 | 44.1 | 60.2 |
| 41.5 | 44.3 | 60.3 |
| 42 | 44.5 | 60.4 |
| 42.5 | 44.7 | 60.4 |
| 43 | 44.9 | 60.5 |
| 43.5 | 45.1 | 60.5 |
| 44 | 45.3 | 60.6 |
| 44.5 | 45.5 | 60.6 |
| 45 | 45.6 | 60.7 |
| 46 | 46 | 60.8 |
| 47 | 46.2 | 60.9 |
| 48 | 46.6 | 61 |
| 49 | 46.9 | 61.1 |
| 50 | 47.2 | 61.3 |
| 51 | 47.3 | 61.2 |
| 52 | 47.8 | 61.4 |
| 53 | 48.2 | 61.5 |
| 54 | 48.5 | 61.6 |
| 55 | 48.9 | 61.8 |
| 56 | 49.3 | 61.9 |
| 57 | 49.3 | 62 |
| 58 | 49.6 | 62.1 |
| 59 | 50.2 | 62.2 |
| 60 | 50.3 | 62.3 |

As indicated by the data collected in Table 3, and plotted in FIG. 6, in one example the aqueous salt solution maintained a temperature of the milk containing food product of less than 50° F. (10° C.) for up to about 60 minutes. During this time period, the temperature of the milk containing food product that was present in the food container that did not include the aqueous salt solution increased to greater than 60° F. (15.6° C.).

While the present disclosure has been particularly shown and described with respect to preferred embodiments thereof, it will be understood by those skilled in the art that the foregoing and other changes in forms and details may be made without departing from the spirit and scope of the present invention. It is therefore intended that the present invention not be limited to the exact forms and details described and illustrated, but fall within the scope of the appended claims.

What is claimed is:

1. A food container comprising:
an inner wall defining a food-containing cavity;
an outer wall defining a geometry of the food container, wherein the outer wall is in contact with the inner wall to provide a unitary structure encapsulating a chamber between the inner wall and the outer wall; and
an aqueous salt solution contained within the chamber between the inner wall and the outer wall, wherein the aqueous salt solution has a water to salt by volume ratio that ranges from 2.5 parts water to 1 part salt to 3.5 parts water to 1 part salt.

2. The food container of claim 1, wherein the aqueous salt solution maintains a temperature for contents of the food-containing cavity at a value below 10° C. for a time period of less than 2 hours.

3. The food containing of claim 2, wherein the contents of the food-containing cavity comprises milk, and the aqueous salt solution maintains the temperature of the milk in a liquid state between a value ranging from −0.5° C. and 10° C. for a time period greater than 30 minutes.

4. The food container of claim 1, wherein a salt of the aqueous salt solution is sodium containing salt that is selected from the group consisting of sodium chloride, sodium acetate, sodium adipate, sodium alginate, sodium aluminium phosphate, sodium aluminosilicate, sodium ascorbate, sodium benzoate, sodium bicarbonate, sodium bisulfite (sodium hydrogen sulfite), sodium carbonate, sodium carboxymethylcellulose, sodium citrates, sodium dehydroacetate, sodium erythorbate, sodium erythorbin, sodium ethyl para-hydroxybenzoate, sodium ferrocyanide, sodium formate, sodium fumarate, sodium gluconate, sodium hydrogen acetate, sodium hydroxide, sodium lactate, sodium malates, sodium metabisulfite, sodium methyl para-hydroxybenzoate, sodium nitrate, sodium nitrite, sodium orthophenyl phenol, sodium propionate, sodium propyl para-hydroxybenzoate, sodium sorbate, sodium stearoyl lactylate, sodium succinates, sodium salts of fatty acids, sodium sulfite, sodium tartrates, sodium tetraborate, and combinations thereof.

5. The food container of claim 1, wherein a salt of the aqueous salt solution is selected from the compound and sodium salt of the compound that is selected from the group consisting of ascorbyl palmitate (palmitoyl L-ascorbic), calcium L-ascorbate, calcium hypophosphite, calcium propionate, carboxymethyl cellulose, cellulose acetate, copper (cupric) gluconate, copper (cupric) sulfate, cuprous iodide, erythorbic acid (D-isoascorbic acid), ethyl cellulose, hydroxypropylmethyl cellulose, L-ascorbic acid, manganous hypophosphite, methylcellulose, potassium hypophosphite, propionic acid, sodium carboxymethyl cellulose, sodium chloride, sodium L-ascorbate, sodium erythorbate (sodium D-isoascorbate), sodium hydrosulfite, sodium hypophosphite, sodium propionate, sodium thiosulfate and combinations thereof.

6. The food container of claim 1, wherein the salt of the aqueous salt solution is food grade sodium chloride having an impurity level of not more than 2 mg/kg of copper, an impurity level of not more than 2 mg/kg of lead, an impurity level of not more than 0.5 mg/kg of cadmium, and an impurity level of not more than 0.1 mg/kg of mercury.

7. The food container of claim 1, wherein at least one of the inner wall and the outer wall are comprised of a plastic that is selected from the group consisting of polyethylene terephthalate (PET), high density polyethylene (HDPE), polyvinyl chloride (PVC), low density polyethylene (LDPE), polypropylene (PP), polystyrene (PS), or a combination thereof.

8. The food container of claim 1, wherein the inner wall and the outer wall of the food container are in contact at a rim of the food container.

9. The food container of claim 8, wherein the rim of the food container is provided by a ring that is connecting the inner wall to the outer wall of the food container.

10. The food container of claim 1, wherein the geometry of the food container has a greater width and depth than a height of the food container.

11. A method of cooling a food product comprising:
providing a food container comprising a cavity for containing a food product, and at least one surface including an enclosed chamber containing an aqueous salt solution, wherein the aqueous salt solution has a salt to water ratio that ranges from 2.5:1 to 3.5:1;
applying the food container to a refrigeration container having a temperature within a range of −18° C. to 10° C.; and
positioning the food product within the cavity of the food container, wherein the aqueous salt solution maintains a temperature of the food product with a range from −0.5° C. and 10° C. for a time period greater than 30 minutes from when the food container is removed from the refrigeration container.

12. The method of claim 11, wherein the aqueous salt solution maintains a temperature of the food product with a range from −0.5° C. and 10° C. for a time period of less than 120 minutes from when the food container is removed from the refrigeration container.

13. The method of claim 11, wherein the aqueous salt solution maintains a temperature of the food product with a range from −0.5° C. and 10° C. for a time period of less than 90 minutes from when the food container is removed from the refrigeration container.

14. The method of claim 11, wherein the aqueous salt solution maintains a temperature of the food product with a range from −0.5° C. and 10° C. for a time period of less than 60 minutes from when the food container is removed from the refrigeration container.

15. The method of claim 11, wherein a salt of the aqueous salt solution is sodium containing salt that is selected from the group consisting of sodium chloride, sodium acetate, sodium adipate, sodium alginate, sodium aluminium phosphate, sodium aluminosilicate, sodium ascorbate, sodium benzoate, sodium bicarbonate, sodium bisulfite (sodium hydrogen sulfite), sodium carbonate, sodium carboxymethylcellulose, sodium citrates, sodium dehydroacetate, sodium erythorbate, sodium erythorbin, sodium ethyl para-hydroxybenzoate, sodium ferrocyanide, sodium formate, sodium fumarate, sodium gluconate, sodium hydrogen acetate, sodium hydroxide, sodium lactate, sodium malates, sodium metabisulfite, sodium methyl para-hydroxybenzoate, sodium nitrate, sodium nitrite, sodium orthophenyl phenol, sodium propionate, sodium propyl para-hydroxybenzoate, sodium sorbate, sodium stearoyl lactylate, sodium succinates, sodium salts of fatty acids, sodium sulfite, sodium tartrates, sodium tetraborate, and combinations thereof.

16. The method of claim 11, wherein a salt of the aqueous salt solution is selected from the compound and sodium salt of the compound that is selected from the group consisting of ascorbyl palmitate (palmitoyl L-ascorbic), calcium L-ascorbate, calcium hypophosphite, calcium propionate, carboxymethyl cellulose, cellulose acetate, copper (cupric) gluconate, copper (cupric) sulfate, cuprous iodide, erythorbic acid (D-isoascorbic acid), ethyl cellulose, hydroxypropylmethyl cellulose, L-ascorbic acid, manganous hypophosphite, methylcellulose, potassium hypophosphite, propionic acid, sodium carboxymethyl cellulose, sodium chloride, sodium L-ascorbate, sodium erythorbate (sodium D-isoascorbate), sodium hydrosulfite, sodium hypophosphite, sodium propionate, sodium thiosulfate and combinations thereof.

17. The method of claim 11, wherein the chamber is present in at least one of a sidewall or a base of the food container, and at least one of the sidewall or the base of the food container is composed of a plastic that is selected from the group consisting of polyethylene terephthalate (PET), high density polyethylene (HDPE), polyvinyl chloride (PVC), low density polyethylene (LDPE), polypropylene (PP), polystyrene (PS), or a combination thereof.

18. The method of claim 11, wherein the food product comprises liquid milk with dry cereal, wherein the aqueous salt solution maintains a temperature of the liquid milk that does not result in freezing of the liquid milk.

19. The method of claim 11, wherein the food product comprises ice cream, frozen custard, frozen yogurt, sorbet, gelato, ais kacang, dondurma, frozen custard, frozen yogurt, halo-halo, ice milk, popsicle (ice pop or ice lolly), sweatened ices, kulfi, mellorine, parevine, sherbet, sorbet, snow cones or a combination thereof.

20. The method of claim 11, wherein the refrigeration container is an ice box, a cooler, a freezer, or a refrigerator.
